(19) United States
(12) Patent Application Publication
(10) Pub. No.: US 2019/0031848 A1
(43) Pub. Date: Jan. 31, 2019

(54) MULTI-LAYERED STRUCTURE OF AT LEAST A BASE-LAYER COMPRISING GLASS FIBRES AND A PAINT-BASED PROTECTIVE LAYER OR A PASTE-BASED PROTECTIVE LAYER

(71) Applicant: Beele Engineering B.V., Aalten (NL)

(72) Inventor: Johannes Alfred Beele, Aalten (NL)

(21) Appl. No.: 15/778,216

(22) PCT Filed: Nov. 23, 2016
(86) PCT No.: PCT/EP2016/078533

§ 371 Date: May 22, 2018

(30) Foreign Application Priority Data
Nov. 23, 2015 (NL) 1041586

(51) Int. Cl. C08J 7/04; C09D 5/18; C08J 5/00; F16L 5/04; F16L 57/04

(52) U.S. Cl. CPC C08J 7/047; C09D 5/18; C08J 2363/00; F16L 5/04; F16L 57/04; C08J 5/005

(57) ABSTRACT

A multi-layered structure of at least a base-layer comprising glass fibers and a paint-based protective layer or a paste-based protective layer, the protective layer being non-intumescent, wherein the protective layer exhibits at atmospheric pressure during an increase in ambient temperature, a drop in its thermal conductivity.

### INTRODUCTION

Base-layers comprising glass fibers are nowadays widely used. The glass fibers are to reinforce the mechanical properties of the base-layer. The glass fibers may be randomly arranged, flattened into a sheet, woven into a fabric, or for instance wound around a pipe to form part thereof. Such a base-layer normally further comprises a plastic which may be a thermosetting plastic, most often epoxy, polyester resin, or phenolester, or a thermoplastic.

Glass fibers can be of various types of glass, mostly containing silica or silicate, with varying amounts of oxides of calcium, magnesium and sometimes boron. Glass fibers are made with a very low levels of defects. Applications of base-layer materials comprising glass fibers include aircraft, boats, automobiles, bathtubs, swimming pools, hot tubes, water tanks, roofing, and nowadays even oil pipes. The materials used in such products may also be referred to as glass-reinforced plastic (GRP) and sometimes glass reinforced epoxy (GRE). Typically glass fibers are used for the production of pipes, wherein glass fiber filaments are wound around the pipe. An example is described in EP 1 386 104.

Although base-layers having glass fibers have many superior qualities which cannot easily be found in other materials, such as the combination of being both strong and light, the performance of such a base-layer upon exposure to heat is problematic. Although the glass fibers most often can easily sustain exposure to a high temperature, the other materials in such a base-layer, most often a plastic, will weaken and deteriorate. On exposure to heat, for instance due to a nearby fire, there is a risk that premature leakage through the base-layer may occur. As most of the applications of these materials are related to containing or guiding a liquid, problems such as leakage may occur. This is particularly relevant when the liquids of concern are volatile and/or would cause pollution of the environment. Particularly oil pipes having a base-layer comprising glass fibers, usually GRE pipes, are ideally well protected against heat.

### SUMMARY OF THE DISCLOSURE

Provided is a multi-layered structure of at least a base-layer comprising glass fibers and a paint-based protective layer or a paste-based protective layer. The protective layer is non-intumescent. The protective layer exhibits at atmospheric pressure during an increase in ambient temperature, a drop in its thermal conductivity.

The ambient temperature is the air temperature of the environment in which the protective layer is kept.

The protective layer is non-intumescent, meaning that it does not puff up to form a foam when the temperature of the layer increases. The protective layer can be paint-based or paste-based, as will be explained further below. It can be applied to base-layers which are already in use. Thus, for instance, existing oil pipes can be provided with such a protective base-layer.

This coating improves its thermal insulation properties when exposed to higher temperatures, such as generated by a nearby fire. Advantageously, when the need arises to protect the multi-layered structure comprising glass fibers against heat, the protective layer responses to that need. Consequently, multi-layered structures according to the present disclosure can function for much longer when a fire occurs at such a distance that the ambient temperature rises. Environmental disasters and loss of human lives may be prevented from occurring. There will be more time available for rescue services and response teams to respond to nearby fires and to act appropriately.

In an embodiment of such a layer comprising glass fibers, the protective layer has a porous structure and/or forms pores at elevated temperatures. Without wishing to be bound by any theory, it is believed that these pores contribute significantly to a drop in the thermal conductivity of the protective layer, particularly at higher temperatures.

In a material having a porous structure, the thermal conductivity is to an extent determined by conduction of heat by gas. The pores provide many transitions from a pore, i.e. a small cavity (in which heat can be conducted by gas) to a material through which no conduction by gas can occur. A heated gas molecule can collide with the surface of the material, and as such pass on some of the thermal energy. However, such a collision will largely be elastic, so that the back-bouncing gas molecule will not have passed on much of its thermal energy to the material. As a consequence of this phenomenon, the thermal energy is effectively kept in the gas. The heat is not efficiently transported through the entire protective layer. This may explain, at least to an extent, the low thermal conductivity of the protective layer.

It is believed that also thermal conductivity by means of radiation (more detailed below) is suppressed in a material having pores. The smaller the pores, the smaller the thermal conductivity by radiation, is presently believed.

A number of different ways of forming a porous structure at elevated temperatures will be mentioned below. A way of forming pores at elevated temperatures could occur by evaporation of liquids out of the protective layer at elevated temperatures, leaving at these higher temperatures empty pores, or cavities, behind. It will also be possible to form pores by spraying material forming the paint-based protective layer onto the metal base-layer. Further, as discussed below, the type of material and size of its particles may be such that pores are formed.

In an embodiment, the pores comprise pores having a diameter of less than 700 nanometers. Again, without wishing to be bound by any theory, it is believed that such small pores contribute very significantly to a drop in thermal conductivity of the protective layer, when the ambient temperature rises, for instance, due to a nearby fire. First of all, many small pores would also mean many transitions between a cavity and a material. The heat will predominantly remain within the gas as the transitions do not provide smooth transfers of heat from the gas to the material and vice versa. The transport of the thermal energy will be frustrated.

Preferably the pores comprise pores having a diameter of less than 70 nanometers. Where the main mechanism for transport of thermal energy is based on conduction of heat by gas, the transport mechanism can also be described as inelastic collisions of a gas molecule having a lot of thermal energy with a gas molecule having less thermal energy. It is thus the number of these collisions that determines to an extent the thermal conductivity of heat through a gas. A parameter related to the number of collisions is the so-called mean-free path of a gas molecule. This is defined as the average distance traveled by a moving gas molecule between successive collisions. The length of this mean-free path is known to increase with the temperature of the gas. If the mean-free path of the gas is longer than the diameter of the cavity in which the heated gas molecule is present, then the gas molecule is more likely to first hit the surface of the material that forms the boundary of the cavity, than with another gas molecule. As explained above, the gas molecule may on colliding with a material pass on some of its thermal energy, but the majority will remain with the gas molecule. For many gas molecules, particularly air molecules (oxygen molecules and nitrogen molecules) the mean-free path at elevated temperatures is higher than 70 nanometers. Collisions between gas molecules are then thus rare. A heated gas molecule has very little chance to pass on energy to another gas molecule. Conduction of heat through the gas phase is now thus even further frustrated. Accordingly, it is believed that heat cannot be swiftly transported through a material comprising many pores having a diameter of less than 70 nanometers, if the predominant mechanism for transport of heat is based on gas conduction.

In an embodiment the protective layer comprises clusterings of particles having a size within the range of 2-300 nanometers.

So far consideration is mainly given to heat conduction by gas. However, heat can also be transported through materials. Thus the bit of heat energy passed on to a material during a collision of a gas molecule with that material, could possibly “travel” down a temperature gradient in that material. Two mechanisms are known. One mechanism is based on electrons which pass on thermal energy. This is why metals, considered to have many so-called free electrons, are good heat conductors. Another mechanism is based on atoms which pass on thermal energy. It turns out that the more rigid the atomic structure is, and the more pure the structure is, the more likely it is that this mechanism for transport of heat works really well. In support of this view, it is to be noted that a single crystal diamond is one of the best heat conductors (having a very rigid and often pure atomic structure), even though it is electrically insulating (that is, no of the electrons are available for transport of heat through the material.

Advantageously, such a structure comprising clusterings of particles having a size within the range of 2-300 nanometers, has more likely many pores and thus the chracteristics described above.

Further, such a structure leads to a material having many impurities in the sense that each boundary of a particle, particularly when placed against the boundary of another particle, forms an irregularity in the structure of the particle.

Furthermore, due to the many pores, the material is also not dense, and not rigid. The result is that heat cannot efficiently be passed on from the structure of one particle to the structure of another particle. This does inherently lead to a low thermal conductivity of that material itself, i.e. regardless of the low thermal conductivity of gas in pores that may be present in such a material.

Furthermore, the presence of clusterings of nanoparticles, not only introduces irregularities, there are also “bottlenecks” formed where the particles join. It is believed that such necking between nanometer-sized particles introduces a problem for the heat to be passed on through the materials, based on, effectively, phonon-transport. Such a resistance contributes to a further drop in thermal conductivity of that material itself, i.e. regardless of the low thermal conductivity of gas in pores that may be present in such a material. This contributes to the low thermal conductivity of the protective layer.

In an embodiment, the pores are formed at temperatures in the range of 180-500° C. Consequently, it is possible that the outer layer of the protective layer being heated up by the higher ambient temperatures forms (more) pores, and as such contributes immediately more intensively to reducing the thermal conductivity of the remaining part of the protective layer before it weakens. As a result of that, the protective layer protects the base-layer against exposure to higher temperatures.

The formation of pores at temperatures in the range of 180-500° C. may be a result of release of water that at lower temperatures was bound to particles included in the protective layer.

In an embodiment the protective layer comprises opacities for reducing heat transfer by radiation.

Heat transfer by radiation, often referred to as thermal radiation, is electromagnetic radiation generated by the thermal motion of charged particles in matter. The surface of a heated material may emit such radiation through its surface. This is typically Infrared radiation. The rate of heat transfer by radiation is dependent on the temperature of a surface. With an increasing temperature, the heat transfer by radiation increases rapidly. Opacifiers in a material counteract that mechanism, for instance by scattering the radiation, or by absorbing the radiation. An example of an opacifier that scatters radiation is titanium dioxide. An example of an opacifier that absorbs radiation is carbon soot. Transparency of the material tends to become lower when opacifiers are used.

It is further believed that thermal conductivity by means of radiation is suppressed in a material that contains pores. The smaller the pore, the smaller the transfer of thermal energy by radiation.

The protective layer is preferably a fire-retardant layer so that when a fire reaches the layer, it will exhibit low flame-spreading characteristics and exhibit “no-combustion” characteristics. It will sustain in a fire for a significant amount of time.

Preferably the fire-retardant layer is non-combustible in a fire reaching a temperature of up to 1100° C.

Preferably, the protective layer is within the temperature range of 50-1100° C. effectively free from shrinkage. This ensures that the protective layer does not generate cracks and tears and it will thus maintain a continuous layer carrying out its protective function.

Preferably the protective layer is within the temperature range of 50-1100° C. effectively free from thermal expansions. Advantageously, original dimensions can be maintained and no allowances need to be made for expansion upon exposure to heat.

In an embodiment a protective layer has a base-layer side and an ambience side, wherein the protective layer is impermeable to gas when a pressure difference of 30 mBar is set between the base-layer side and the ambience side.

Preferably the protective layer is salt water resistant. This is of particular relevance when the multi-layered structure is provided onboard of a construction that will be out on the sea/ocean, or otherwise in proximity of seawater.

Preferably the resistance to salt water is maintained when the protective layer has been exposed to a fire. This ensures that even when a fire has occurred there is no need to replace the multi-layered structure and the protective layer for reasons that it would no longer be resistant to salt water.

In an embodiment, the sprayed-on protective layer is a layer formed by spraying a water-based polymer emulsion onto the base-layer.

In an embodiment, the protective layer is impermeable to water.

In an embodiment,the base-layer comprises a Glass Fiber Reinforced Plastic (GRP) layer.

In an embodiment, the base-layer forms at least a part of a pipe.

In an embodiment, the metal base-layer forms at least a part of a plate-shaped construction element.

In an embodiment, the base-layer forms at least a part of ship, an oil platform, or an engineered construction for use on the sea.

In an embodiment, the base-layer forms at least a part of a chemical or petrochemical factory.

In an embodiment, the base-layer forms at least a part of an oil storage tank.

The disclosure also relates to a paint or paste formed using a water-based polymer emulsion, suitable for forming a protective layer for forming a multi-layered structure according to any of the embodiments covered by the present disclosure.

The disclosure is further explained on the basis of a drawing, in which:

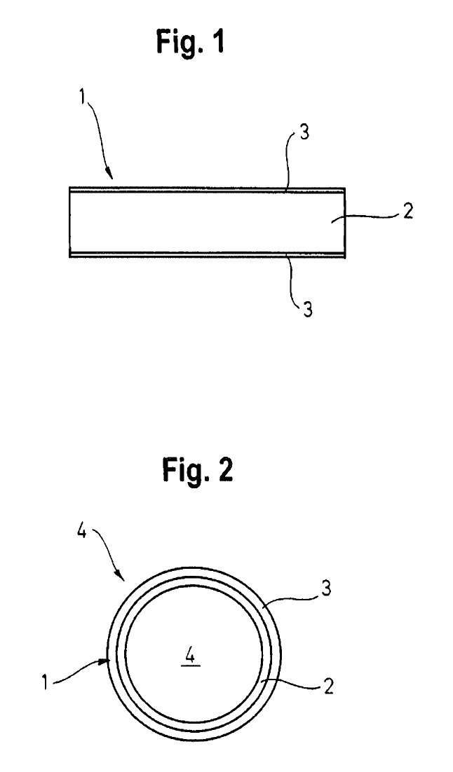

FIG. 1 shows in cross-section the first embodiment of a multi-layered structure according to the present disclosure;

FIG. 2 shows schematically in cross-section a second embodiment of a multi-layered structure according to the present disclosure;

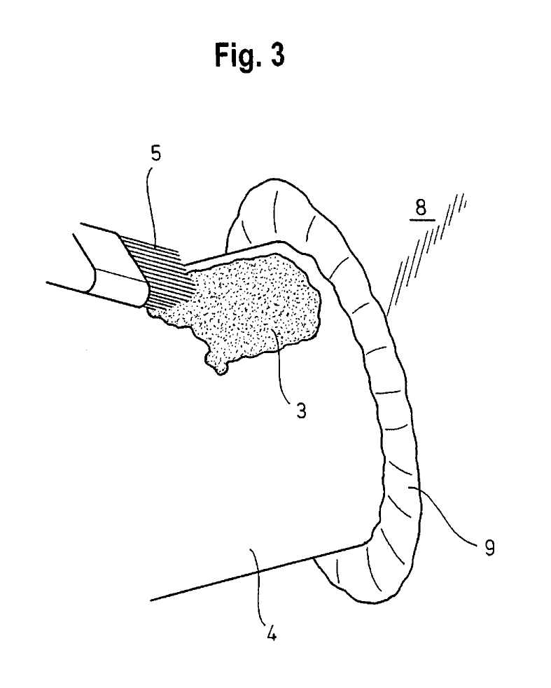

FIG. 3 shows a step in a method of making a multi-layered structure according to the present disclosure;

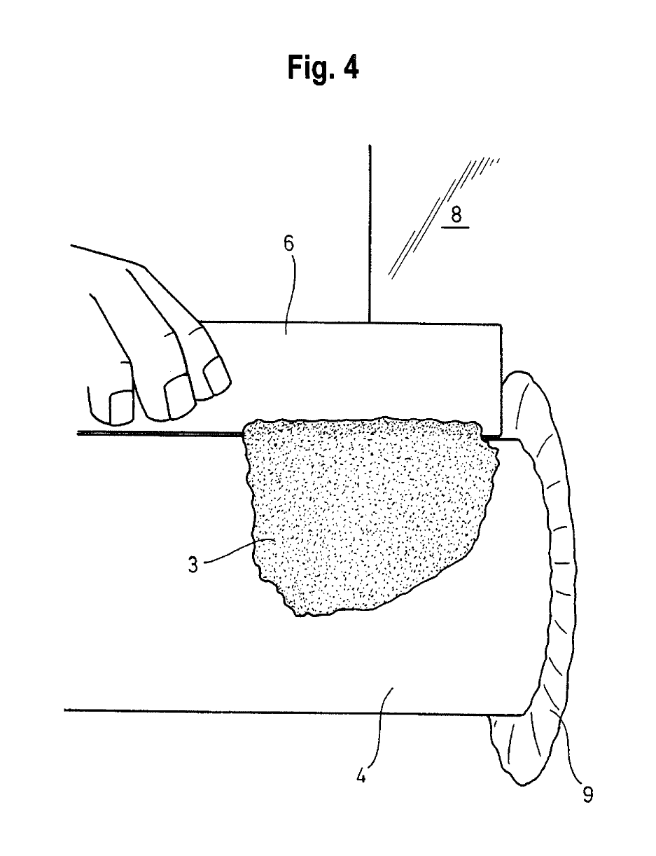

FIG. 4 shows a step in a method of making a multi-layered structure according to the present disclosure;

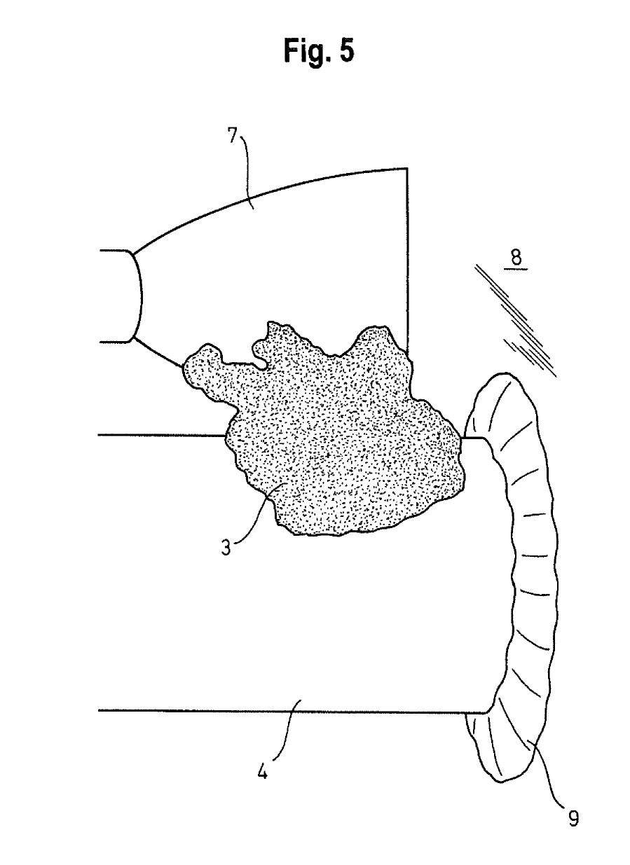

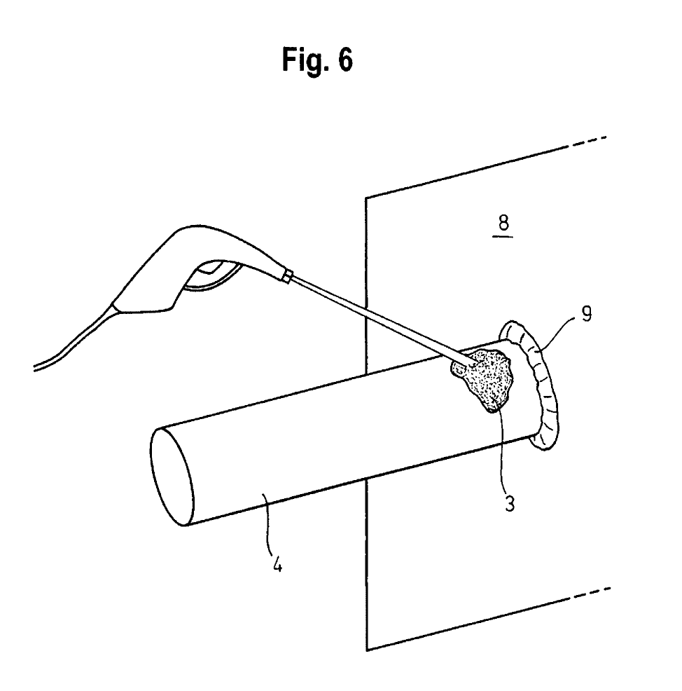

FIG. 5 shows a step in a method of making a multi-layered structure according to the present disclosure; and

FIG. 6 shows a step in an alternative way of a method for making a multi-layered structure in accordance with the present disclosure.

In the description of the drawing, like parts are provided with like references.

FIG. 1 shows in cross-section a multi-layered structure 1 of a metal base-layer 2 and a paint-based protective layer 3. Instead of the paint-based protective layer 3, a paste-based protective layer 3 may be applied. The protective layer 3 is non-intumescent, i.e. it does on exposure to heat not puff up to produce a foam. The protective layer 3 exhibits at atmospheric pressure during an increase in the ambient temperature, a drop in its thermal conductivity. The ambient temperature is the air temperature of the environment in which the protective layer is kept.

FIG. 2 shows in cross-section a pipe 4 having a multi-layered structure 1 according to the embodiment of the present disclosure.

The protective layer 3 may be based on paint. Alternatively, the protective layer 3 is based on a paste.

FIGS. 3, 4 and 5 show the application of the protective layer based on a paste. In FIG. 3 a brush 5 is used. In FIG. 4 a squeegee 6 is used. In FIG. 5 a putty knife 7 is used.

The application shown is on a pipe 4 as extending out of a conduit (not shown) in a wall 8. A sealant 9 is applied to seal the annular gap between the pipe 4 and the conduit. However, a person skilled in the art can easily envisage how the application similarly would be applicable onto a flat base-layer.

FIG. 6 shows the application of the base-layer on the basis of a paint, in this example by means of spraying.

The base-layer may be a so-called GRP or GRE layer. The base-layer may be part of a pipe or part of a plate-shaped construction element. Any other shape is also possible.

The thickness of the layer can be as desired. Spraying for longer, or spraying more layers, will result in a thicker protective layer. The density of the protective layer can be varied, throughout the layer, or held constant per layer. The density can be varied, depending on the number and density of pores.

The protective layer 3 is non-intumescent, meaning that it does not puff up to form a foam when the temperature of the layer increases. The protective layer 3 can be provided by applying a waterbased polymer emulsion, such as the so-called “FISSIC coating”, as commercially available from the applicant (www.fissiccoating.com). The emulsion is available in paint form as well as in paste form.

The protective layer 3 has a porous structure and/or forms pores at elevated temperatures. A porous structure may be present in the particles which at least partly make up the protective layer but may also be formed at elevated temperatures, for instance by release of bonded water out of the protective layer. Pores may also have been formed by the way the protective layer is applied, i.e. by entrapping air into the layer during spraying of the water-based polymer emulsion onto the base-layer 2. The pores may comprise pores having diameters of less than 700 nanometers. Preferably the pores comprise also pores having a diameter of less than 70 nanometers. The pore structure may comprise clusterings of particles having a size within the range of 2-300 nanometers. It is preferable that a number of the pores are formed at temperatures in the range of 180-500° C.

The protective layer may comprise opacities for reducing heat transfer by radiation. Opacities are known in the art, a typical example is titanium dioxide. Another typical example is carbon soot.

The protective layer 3 is preferably a fire-retardant layer. To this end, highly suitably, borates conventionally used as fire retardants; plasticizers of the organic phosphate type such as trialkyl phosphates and triaryl phosphates, and in particular trioctylphosphate, triphenylphosphate and diphenyl cresyl phosphate; solid fire retardants such as ammonium polyphosphate, for instance Antiblaze MC®: and melamine polyphosphate (melapur 200) can be used. These and more fire retardants are well known in the art.

The fire retardant layer is preferably non-combustible in a fire reaching a temperature up to 1100° C. The protective layer 3 is within a temperature range of 50-1100° C. effectively free from shrinkage and, preferably, free from thermal expansion.

The protective layer 3 is salt water resistant, preferably even after fire. Reference is made to KIWA Netherlands report 20150421 HN/01 for the performance of the so-called “FISSIC coating” in this respect. The protective layer 3 is impermeable to water and/or impermeable to gas (at least when the gas pressure difference is 30 mBar. The protective layer prevents corrosion under isolation (CIU) from taking place.

A sprayable emulsion suitable for forming by spraying a protective layer according to the present disclosure is on the day of this disclosure available, at least via the website www.fissiccoating.com both in paint form and in paste form.

The base-layer may form part of at least a part of ship, an oil platform, or an engineered construction for use on the sea.

The base-layer may form part of at least a part of a chemical or petrochemical factory.

The base-layer may form part of at least a part of an oil storage tank.

Many applications, each making use of embodiments of the present disclosure, are easily conceivable. Not only in a maritime climate/environment but also in the chemical and petrochemical industry, and in the building industry, use can be made of embodiments of this disclosure.

1. A multi-layered structure of at least a base-layer comprising glass fibers and a paint-based protective layer or a paste-based protective layer, the protective layer being non-intumescent, wherein the protective layer exhibits at atmospheric pressure during an increase in ambient temperature, a drop in its thermal conductivity.

2. The multi-layered structure of claim 1, wherein the protective layer has a porous structure or forms pores at elevated temperatures.

3. The multi-layered structure of claim 2, wherein the pores comprise pores having a diameter of less than 700 nanometers, and preferably less than 70 nanometers.

4. The multi-layered structure of claim 12, wherein the porous structure comprises clusterings of particles having a size within a range of 2 to 300 nanometers.

5. The multi-layered structure according to claim 4, wherein pores are formed at temperatures in a range of 180° C. to 500° C.

6. The multi-layered structure of claim 1, wherein the protective layer comprises opacities for reducing heat transfer by radiation.

7. The multi-layered structure of claim 1, being free from a primer layer between the base-layer and the protective layer.

8. The multi-layered structure of claim 7, being free from any other layer between the base-layer and the protective layer.

9. The multi-layered structure of claim 1, wherein the protective layer is a fire retardant layer.

10. The multi-layered structure of claim 9, wherein the fire retardant layer is non-combustible in a fire reaching a temperature up to 1100° C.

11. The multi-layered structure of claim 1, wherein the protective layer is within a temperature range of 50-1100° C. effectively free from shrinkage.

12. The multi-layered structure of claim 1, wherein the protective layer is within a temperature range of 50-1100° C. effectively free from thermal expansion.

13. The multi-layered structure of claim 1, wherein the protective layer is a layer that is formed using a water-based polymer emulsion.

14. The A multi-layered structure of claim 1, wherein the protective layer is salt water resistant.

15. The multi-layered structure of claim 1, wherein the protective layer has a base-layer side and an ambience side, wherein the protective layer itself is impermeable to gas when a pressure difference of 30 mBar is set between the base-layer side and the ambience side.

16. The multi-layered structure of claim 1, wherein the protective layer is impermeable to water.

17. The multi-layered structure of claim 1, wherein the base-layer comprises a Glass Fiber Reinforced Plastic (GRP) layer.

18. The multi-layered structure of claim 1, wherein the base-layer comprises a Glass Reinforced Epoxy (GRE) layer.

19. The multi-layered structure of claim 1, wherein the base-layer forms at least a part of a pipe.

20. The multi-layered structure of claim 1, wherein the base-layer forms at least a part of a plate-shaped construction element.

21. The multi-layered structure of claim 1, wherein the base-layer forms at least a part of ship, an oil platform, or an engineered construction for use on a sea.

22. The multi-layered structure of claim 1, wherein the base-layer forms at least a part of a chemical or petrochemical factory.

23. The multi-layered structure of claim 1, wherein the base-layer forms at least a part of an oil storage tank.

24. A paint or paste formed using a water-based polymer emulsion, suitable for forming a protective layer for forming the multi-layered structure of claim 1.
